(19) United States
(12) Patent Application Publication
(10) Pub. No.: US 2006/0150825 A1
(43) Pub. Date: Jul. 13, 2006

(54) Fryer for pasta and potatoes

(75) Inventor: Tahsin Oztiryaki, Istanbul (TR)

Correspondence Address: John S. Egbert;Harrison & Egbert, 7th Floor, 412 Main Street, Houston, TX, 77002, US

(73) Assignee: OZTIRYAKILER MADENI ESYA SANAYI VE TICARET ANONIM SIRKETI, Istanbul (TR)

(21) Appl. No.: 11/095,861

(22) Filed: Mar. 31, 2005

(30) Foreign Application Priority Data
Jan. 7, 2005 (TR) U2005/00074

(51) Int. Cl. A47J 37/12

(52) U.S. Cl. 99/403

(57) ABSTRACT

The fryer for pasta and potatoes for use in cooking high amounts of ingredients in industrial kitchens reduces the cooking time (cooking time comprises pre-heating time, normal cooking time and re-cooking time) by transferring a high heat to the cooking pool as fast as possible. The fryer has a cooking reservoir, a heater pipe, a chimney, a burner, a pilot and a burner connection sheet.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

Present invention relates to a fryer (for pasta and potatoes) for use in cooking high amounts of ingredients in industrial kitchens to reduce the cooking time (cooking time comprises pre-heating time, normal cooking time and re-cooking time) by transferring a high heat to cooking pool as fast as possible, which comprises a cooking reservoir (1), a heater pipe (2), a chimney (3), a burner (4), a pilot (5) and a burner connection sheet (6).

### BACKGROUND OF THE INVENTION

There is no such a device currently available at the market.

### BRIEF SUMMARY OF THE INVENTION

The device according to present invention comprises burners at a high KW in order to reduce the cooking time, pipes formed in special geometries suitable for these burners and a body to which these pipes are mounted and formed as a hygienic monoblock (a monolithic structure) so that the reservoir is easily cleaned and waste foods are free of any bacteria.

### BRIEF DESCRIPTION OF THE SEVERAL VIEWS OF THE DRAWINGS

FIG. 1: A general view of a potato fryer.

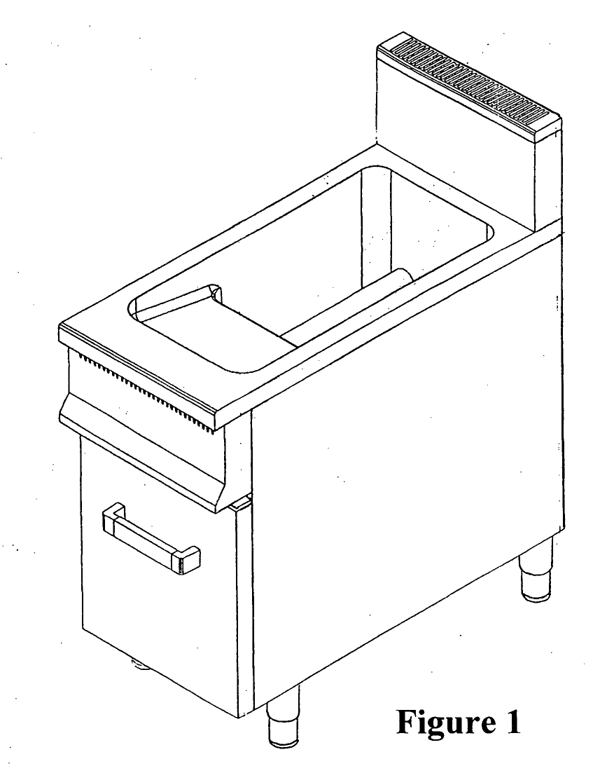

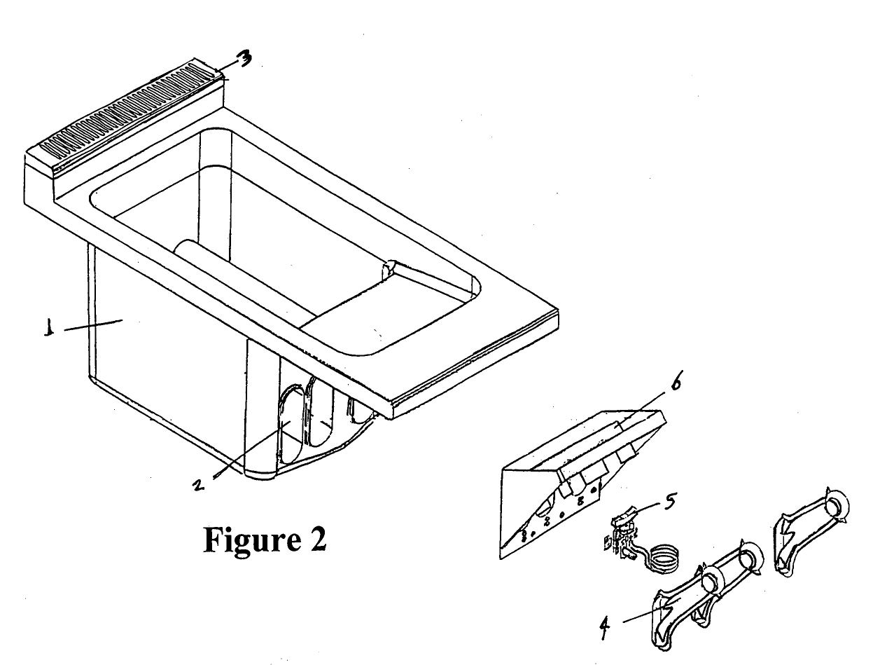

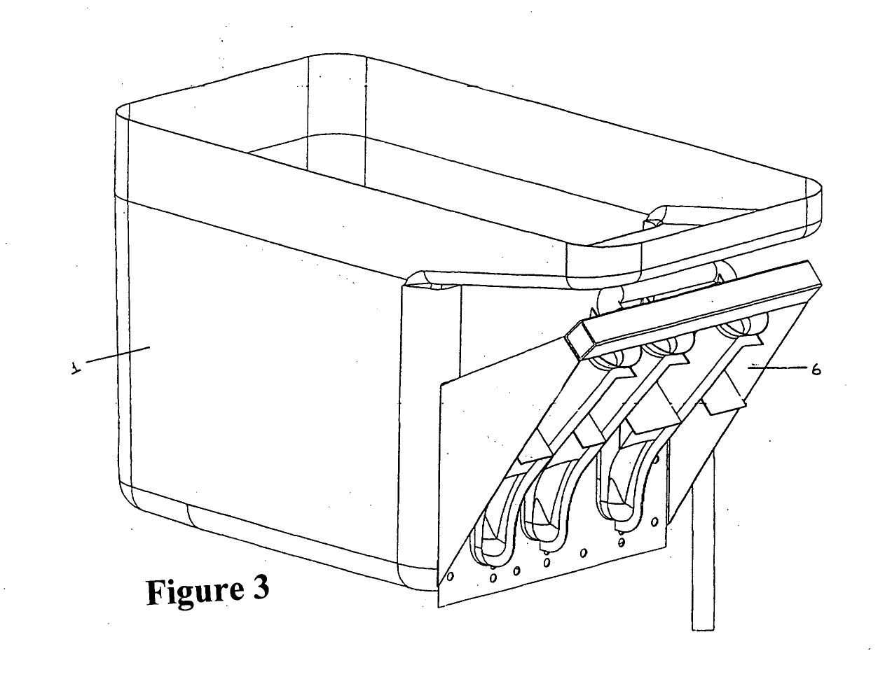

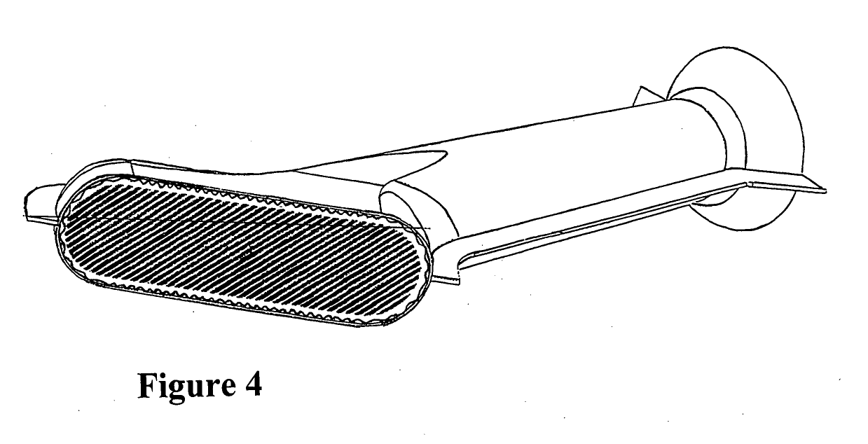

FIG. 2: Potato fryer
(1) Cooking reservoir
(2) Heater pipe
(3) Chimney
(4) Burner
(5) Pilot
(6) Burner connection sheet

FIG. 3: Potato fryer
(6) Burner connection sheet
(1) Cooking reservoir

FIG. 4:
(4) Burner (for potato and pasta)

### DETAILED DESCRIPTION OF THE INVENTION

In the device of present invention, the burners (4) are mounted at an angle of 45° with respect to a vertical axis of the cooking reservoir.

Burning process takes place at the sheet block part located at the serrated geometry at the end of the burner and burning gas is carried to the heater pipes. The burners (4) are designed to provide an efficient and continuous burning at high KWs.

In the device of present invention, pipes (2) are designed to increase the surface of heat transfer in accordance with the geometry of the burners.

The efficiency is increased by lengthening the path taken by the flame, by the means of a flame directing device located in the pipes (2).

The cooking pool of the device of the present invention, is formed by a monolithic (monoblock) deep extraction method and welded to the upper table with a seam welding. The monolithic body offers ease of cleaning and hygiene for reservoir.

The potato fryer is formed with 3 burners and 3 pipes and the pasta fryer is formed with 2 burners and 2 pipes. The cooking reservoir of the pasta fryer is deeper than that of potato fryer.

1. A fryer for pasta and potatoes for use in cooking high amounts of ingredients in industrial kitchens to reduce cooking time, said cooking time comprising pre-heating time, normal cooking time and re-cooking time, by transferring a high heat to cooking pool as fast as possible, said fryer comprising:
a cooking reservoir, a heater pipe, a chimney, a burner, a pilot and a burner connection sheet.

2. A fryer for pasta and potatoes according to claim 1, further comprising:
burners at a high KW in order to reduce the cooking time,
pipes formed in special geometries suitable for these burners and
a body to which these pipes are mounted and formed as a hygienic monolithic structure so that the reservoir is easily cleaned and waste foods are free of any bacteria.

3. A fryer for pasta and potatoes according to Claim I, wherein the burners are mounted at an angle of 45° with respect to a vertical axis of the cooking reservoir, a burning process taking place at the sheet block part located at the serrated geometry at the end of the burner and burning gas is carried to the heater pipes, and the burners providing an efficient and continuous burning at high KWs.

4. A fryer for pasta and potatoes according to claim 1, wherein the pipes increase the surface of heat transfer in accordance with the geometry of the burners, and the efficiency is increased by lengthening the path taken by the flame, by the a flame directing device located in the pipes.

5. A fryer for pasta and potatoes according to claim 1, wherein the cooking pool is comprised of a monolithic deep extraction method and welded to the upper table with a seam welding and the monolithic body offers ease of cleaning and hygiene for reservoir.

6. A fryer for pasta and potatoes according to claim 1, wherein the potato fryer is comprised of 3 burners and 3 pipes and the pasta fryer is formed with 2 burners and 2 pipes, and the cooking reservoir of the pasta fryer is deeper than that of potato fryer.
